(19) United States
(12) Patent Application Publication
(10) Pub. No.: US 2003/0103030 A1
(43) Pub. Date: Jun. 5, 2003

(54) Two-in-one image display/image capture apparatus and the method thereof and identification system using the same

(75) Inventor: Wei-Jyei Wu, Taipei (TW)

Correspondence Address: Ladas & Parry, 26 West 61st Street, New York, NY, 10023, US

(73) Assignee: DESUN SYSTEM INC.

(21) Appl. No.: 10/046,428

(22) Filed: Jan. 16, 2002

(30) Foreign Application Priority Data
Dec. 4, 2001 (TW) 90129991

(51) Int. Cl. G09G 3/36

(52) U.S. Cl. 345/102

(57) ABSTRACT

The present invention provides a two-in-one image display/image capture apparatus and the method thereof. Said two-in-one image display/image capture apparatus has the ability of displaying images, and capturing images, and comprises:

a flat display panel 2, which is non-transparent when said two-in-one image display/image capture apparatus displays images and is transparent when said two-in-one image display/image capture apparatus captures images (the image of the user can pass through said flat display panel 2);

a background light source module 4 located at the backside of said flat display panel 2, which is turned on when said two-in-one image display/image capture apparatus displays images and is turned off when said two-in-one image display/image capture apparatus captures images;

a flat display controller 14, which is used to receive image files from a main controller 8 and display said image files on said flat display panel 2;

an image capturer 6 located at the backside of said flat display panel 2, which is turned off when said two-in-one image display/image capture apparatus displays images and is activated to capture image of the user when said two-in-one image display/image capture apparatus captures images; and

a main controller 8 used to control the image display and image capture of said two-in-one image display/image capture apparatus, which transmits pre-stored image files to said flat display controller 14 and controls said background light source module 4 to open when said two-in-one image display/image capture apparatus displays images and turns on said background light source module 4 and activates said image capturer 6 when said two-in-one image display/image capture apparatus captures images.

### FIELD OF INVENTION

The invention relates to a two-in-one apparatus which has the functions of image display and image capture and the method of using an operational, monitoring and security recording system. One of its characteristics is to put the unit of image capture behind the flat display and make the flat display which only has the image display function, also possess the image capture function.

Under the current techniques the user only recognizes that the flat displays have the image display function. The method provided by the present invention can widen the recognition of the flat display of the user. The user will recognize that any flat display may have both the function of image display and the function of image capture when the present invention is added thereto. Such recognition can apply broadly to many optical fields, especially to the security industry. For example, the displays of the banks' ATMs will have both the image display function and the image capture function if the present invention is installed on them. Since the user has to face directly to the display when operating the ATM, the installed present invention can clearly and completely tape the operating act of the user. Illegal users can hardly keep their act from being taped while using the ATM.

The two-in-one image display/image capture apparatus and the method thereof of the present invention can be installed on and used by those systems which have the flat display function, such as image computers, notebooks, mobile phones, personal digital assistants (PDAs), image phones, ATM, multimedia displays on vehicle, game players and televisions, etc. After installation of the said apparatus of the present invention, those systems can have both the image display function and the image capture function. The system's interactive operational ability will be improved greatly.

The two-in-one image display/image capture apparatus and the method thereof of the present invention can be installed on and used by the systems that currently have flat display function, such as image computers, notebooks, mobile phones, PDAs, image phones, ATM, mobile multi-media displays, electronic players and televisions. The systems with the one-way image display function can utilize the present invention to have the two-way image display/image capture function. The system's interactive ability will be improved a lot.

The present invention also discloses a novel operational, monitoring and security recording system and the method thereof. The present invention can record the images and the acts of the users when they operate the system comprising the apparatus of the present invention. Said method of sequentially digital recording of the users and their act through the two-in-one image display/image capture apparatus of the present invention can make the system operate as a black box. Since said apparatus can store the image files of the user and the operation display files sequentially, it is just like creating an electrical signature of the users and their act. Said method of recording digital identification image files can improve the application of monitoring, security system, biological identification and electrical signature that need digital records.

### BACKGROUND OF THE INVENTION AND RELATED ART

There are plenty of systems which have flat displays that comprise the image capture function. They are available in the market, such as video computers (desk-top or lap-top), mobile phones, video phones, personal digital assistants (PDAs), ATM and televisions, etc. These systems capture images based on the need of interactive function. But those prior art systems all treat image display and image capture as two independent apparatus. Some of them put image capturers on top of or beside the flat displays and the others install the image capturers in the antennas in different spots. Users can easily recognize the operation of the image display and image capture apparatus in the prior arts. Basically, those prior art systems have only tried to optimize the relative positions of the image display apparatus and image capture apparatus by changing their positions.

The prior art systems are listed as follows:

1. The camera is placed beside the display of the notebook (ROC Patent Publication No. 434,496);

2. The camera is placed in the antennas of the mobile phone and the PDA (ROC Patent Publication No. 439,996);

3. The camera is placed on top of the auto cashier of the bank (U.S. Pat. No. 4,991,008);

4. The camera is placed beside the display of the mobile phone (U.S. Pat. No. 5,491,507);

5. The camera is placed on top of the display of the notebook (U.S. Pat. No. 6,118,653).

The Disadvantages of the Prior Arts

1. In all of the above-mentioned prior art the image display and the image capture functions are executed by two independent apparatuses; thus it is needed to consider the relative positions of said two apparatuses. It is extremely important how to place the image capturer in order to get a better shooting angle. But, to put the image capturer, on top of the flat display or beside the flat display cannot have the best shooting angle because the flat display, image capturer and the user are not lined up in a straight line. There is no way to get best pictures.

2. The shapes of the flat display and the image capturer have to be considered in all of the above-mentioned prior arts. Sometimes the shape of the image capturer causes setback when using the flat display. For example, the notebooks, PDAs and mobile phones are required to be light, thin and small. Adding image capturers to the above-mentioned systems with the prior art techniques sometimes has disadvantages such as odd shape, larger size and heavier weight, etc.

3. Under certain circumstances it is better not let the user recognize the existence of some monitoring systems. But in all prior art the image capturers are separated units. The user can easily sense the operation of the image capturers; thus, the image capturers can not be placed without being noticed.

### SUMMARY OF THE INVENTION

The present invention is a novel optical image apparatus which has the image display function and the image capture function. The present invention has the image capturer installed right on the panel behind the flat display, forming a two-in-one image display/image capture apparatus. The present invention sets the flat display panel into two statuses, one is non-transparent image display status and the other is transparent image capture status, which can switch between the two statuses. In the non-transparent status the apparatus is doing the tradition image display. In the transparent status the apparatus has the characteristics that the light of the demanded image can go through the transparent flat display, capturing the light by the image capturer on the flat display panel and saving the images with image storage apparatus to achieve the image capture function.

The two-in-one image display/image capture apparatus of the present invention can switch at a very high speed between the non-transparent image-display status and the transparent image-capture status. If users use the apparatus of the present invention, due to the effect of duration of vision, they can not recognize the interrupt when the panel is switched from the image display status to the image capture status. Thus, the present invention can switch between image display status and image capture status without being noticed by the user, and can use the same apparatus to perform the image display and image capturer.

The present invention is a novel periphery equipment of the computers and the video systems which can break through the stereotypes of the concepts that the image display and the image capture have to be handled by different interfaces, providing a two-in-one image display/image capture apparatus to merge the image display/image capture functions together. By this the present invention has the following advantages:

1. The flat displays of the equipments, such as computers, notebooks, mobile phones, PDAs, video phones, ATM and televisions, etc., can be replaced with the two-in-one image display/image capture apparatuses of the present invention. That can improve the function of those equipments while maintaining their shapes, sizes and weights.

2. Since the flat display, image capturer and the user of the present invention are lined up in a straight line, it is much easier to get best pictures;

3. It is impossible that users will know they have been photographed. It is also impossible that users can avoid being photographed even if they see the existence of the present invention, because they have to look straight at the flat display and can not tell when the system will switch from the image display status to the image capture status;

4. Currently, users can easily notice the operation of the image capturers when they use the systems of the prior arts which have both the image display function and the image capture function. The present invention can avoid the notice of the user. For example, the present invention will generate the best monitoring effect if users have no idea of that there is an image capturer behind the flat display which will record their act for the purpose of monitoring and recording.

5. The present invention comprises a plurality of image capturer 6 located at different spots or located at different angles behind the flat display panel 2 in order to generate 3-dimentional (3D) images of the user or to monitor from several different angles simultaneously.

6. The systems comprising the apparatus of the present invention can use said apparatus as a “black box” recorder. The apparatus of the present invention can store the image files of the user and operation display files sequentially, it is just like creating an electrical signature of the users and their act. Said method of recording digital identification image files can be applied to monitoring equipments, security recording, biological identification and electrical signature that need digital records.

7. The present invention can be applied to identification systems, especially to the application of the biological identification systems, such as irides identification system, fingerprint identification system and visage identification system. A specific spot on said apparatus can be marked in order to guide the user to respond in the process of operation. For example, to guide the user to stare at a specific spot of the flat display panel 2 or guide the user to put a finger on a specific spot of the flat display panel 2. Thus the convenience and the accuracy of the operation will be improved significantly. In the mean time the operating act of the user can also be stored as a complete tracing record in the apparatus of the present invention.

### BRIEF DESCRIPTION OF THE DRAWINGS

This invention will be better understood with reference to the accompanying drawings in which:

FIG. 1A shows the status of the two-in-one image display/image capture apparatus of the present invention during image display;

FIG. 1B shows the status of the two-in-one image display/image capture apparatus of the present invention during image capture;

FIG. 2 shows the architecture of the two-in-one image display/image capture apparatus according to the present invention;

FIG. 3 is the flow chart of activating the sequential recording using the two-in-one image display/image capture apparatus of present invention;

FIG. 4 shows the process to form an electrical signature by sequentially capturing the display images and the user images using the two-in-one image display/image capture apparatus of the present invention;

FIG. 5A is the biological identification system identified by irides files using the two-in-one image display/image capture apparatus of the present invention;

FIG. 5B is the biological identification system identified by fingerprint files using the two-in-one image display/image capture apparatus of the present invention.

### LIST OF REFERENCE NUMERALS OF THE MAJOR PARTS

2 flat display panel

4 background light module

6 image capturer

8 main controller

10 two-in-one controller

12 image capture controller

14 image display controller

16 background light controller

20 image storage apparatus

22 display memory apparatus

### DETAILED DESCRIPTION OF THE PREFERRED EMBODYMENT

A preferred embodiment of the present invention will be described below with reference to the accompanying drawings. The same element in the drawings is represented with the same reference numeral.

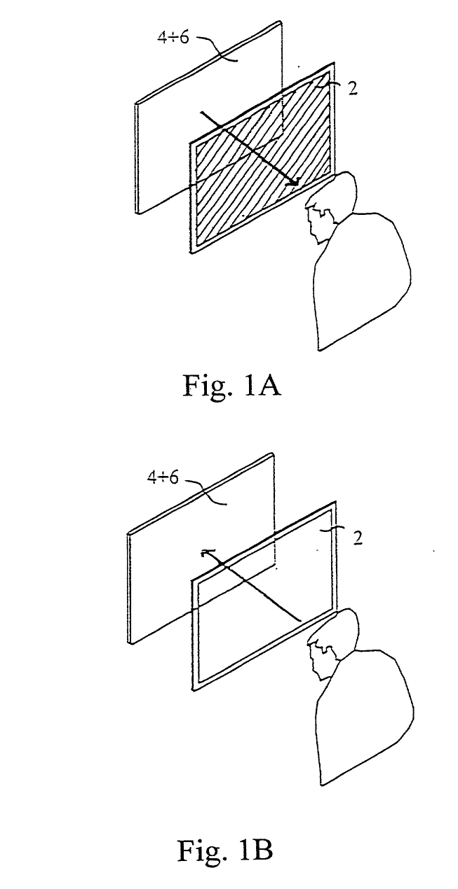

FIG. 1A is the image display status of a two-in-one image display/image capture apparatus based on the present invention. It indicates that the two-in-one image display/image capture apparatus is non-transparent when it is in the image display status. At this moment the background light module 4 is turned on and the image capturer is turned off.

FIG. 1B is the image capture status of a two-in-one image display/image capture apparatus based on the present invention. It indicates that the two-in-one image display/image capture apparatus is transparent when it is in the image capture status. At this moment the background light module 4 is turned off and the image capturer is turned on. The two-in-one image display/image capture apparatus according to the present invention can be equipped with a plurality of image capturers 6 behind the flat display panel 2, to generate 3-dimentional (3D) images of the user or capture images at different angles in order to prevent the user from hiding at a death-angle of a single image capturer.

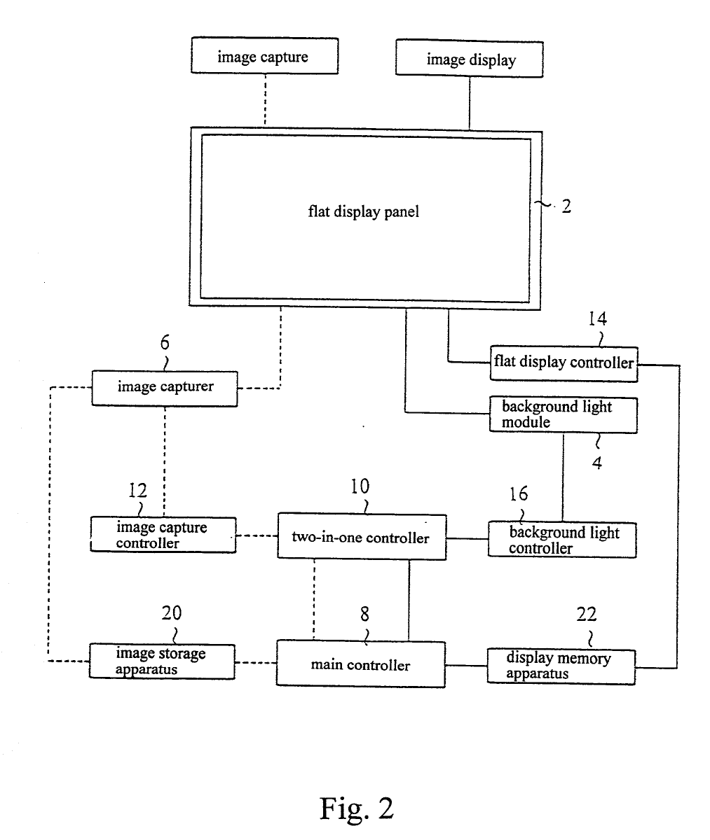

FIG. 2 shows the architecture of the two-in-one image display/image capture apparatus according to the present invention. The relationships among the major parts—the flat display panel 2, the background light module 4, the image capturer 6, the main controller 8, the two-in-one controller 10, the image capture controller 12, the flat display controller 14, the background light module controller 16 and the display memory apparatus 22—are shown in this drawing. When the two-in-one image display/image capture apparatus is in the status of displaying images, the main controller 8 displays the images pre-stored in (for example in the ATM) or received by (for example in the image phone) the display memory apparatus 22 through the image display controller 14 to the flat display panel 2. When the two-in-one image display/image capture apparatus is in the status of capturing images, the main controller 8 controls the image capturer 6 through the image capture controller 12 and captures images through the flat display panel 2.

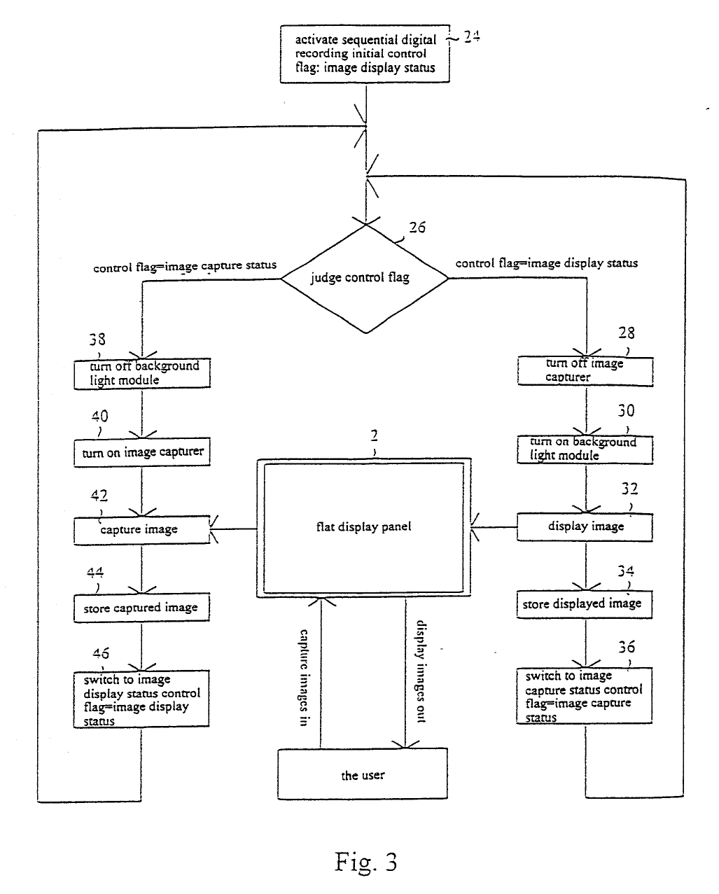

FIG. 3 is the flow chart of activating the sequential recording using the two-in-one image display/image capture apparatus of present invention. The apparatus of the present invention can record the images of the user and the displayed image files sequentially. The act of the user will be recorded by digital recorder completely through the following steps: (1) when the user operates the two-in-one image display/image capture apparatus of present invention, the apparatus executes step 24 first to activate the sequential digital recording. The initial control flag is equal to the image display status at this moment which means that said apparatus is in the image display status; (2) step 26 judging the control flag is executed. Since the control flag is equal to the image display status at this moment, step 28 is executed to turn off the image capturer 6; (3) step 30 is executed to turn off the background light module 4 and let the light go through the flat display panel 2; (4) step 32 is executed to display images; (5) step 34 is executed to store displayed images; (6) step 36 is executed to switch the apparatus to the image capture status. At this moment the main controller 8 (not shown) changes the control flag to image capture status; (7) step 26 is executed to judge the control flag. Since the control flag is equal to the image capture status at this moment, step 38 is executed to turn off the background light module 4; (8) step 40 is executed to turn on the image capturer 6; (9) step 42 is executed to capture the images of the user; (10) step 44 is executed to store images of the user captured by step 42; (11) step 46 is executed to switch to the image display status. At this moment the main controller 8 (not shown) changes the control flag to image display status; (12) step 26 is executed to judge the control flag; and (13) steps 26→28→30→32→34→36→26→38→40→42→44→46 are executed sequentially and repeatedly to form a digital record by storing the interactive relationship of the displayed images and the images of the user as a electrical signature until the end of operation.

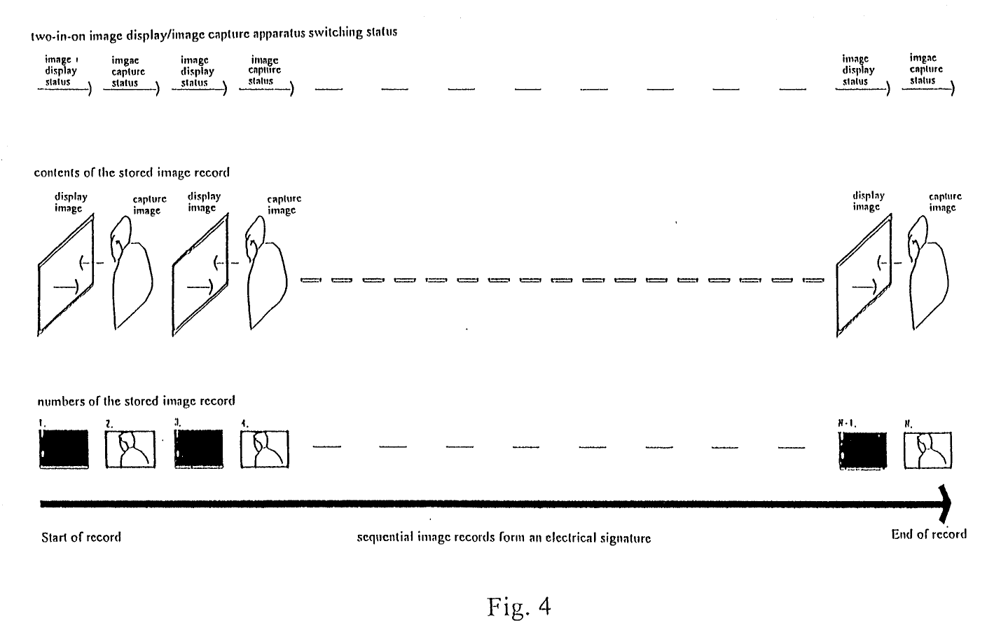

FIG. 4 shows the process to form an electrical signature by sequentially capturing the display images and the user images using the two-in-one image display/image capture apparatus of the present invention, wherein the odd numbers of the stored images stand for the displayed images and the even numbers of the stored images stand for the captured images of the user. These sequential stored images form an electrical signature can be applied to the biological identification.

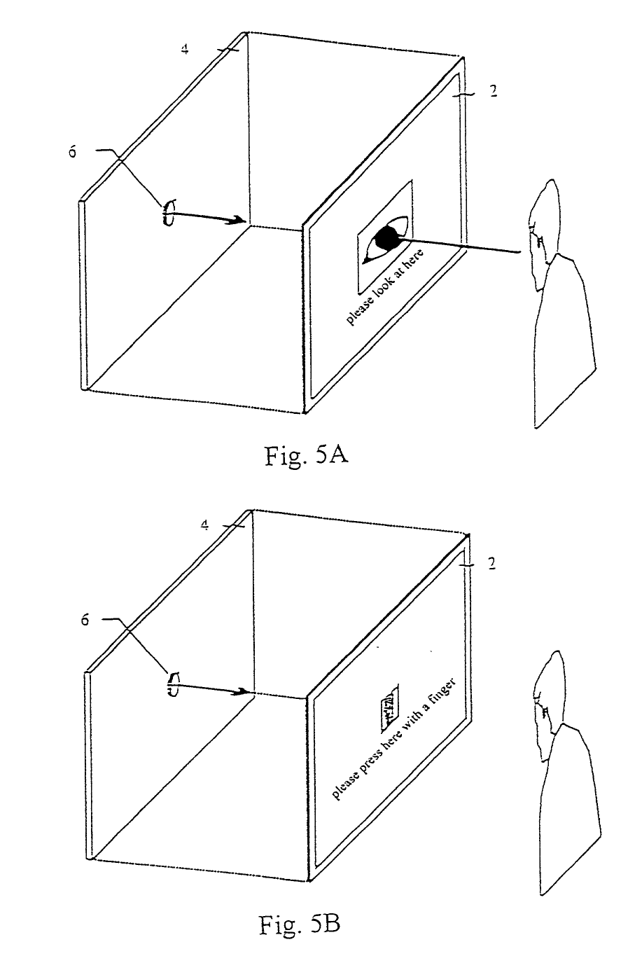

FIG. 5A is the biological identification system identified by irides files using the two-in-one image display/image capture apparatus of the present invention, wherein the user has to follow the instructions to stare at a specific spot of the flat display panel 2 in order to let the biological identification capture the irides files for identification. Said apparatus transmits the irides files to a processor (not-shown) after capture of the irides files from the user. Said processor executes a irides identification program to compare said irides files with the irides image files stored in a database (not shown).

FIG. 5B is the biological identification system identified by fingerprint files using the two-in-one image display/image capture apparatus of the present invention, wherein the user has to follow the instructions to put a finger on a specific spot of the flat display panel 2 in order to let the biological identification capture the fingerprint files for identification. Said apparatus transmits the fingerprint files to a processor (not shown) after capture of the fingerprint files from the user. Said processor executes a fingerprint identification program to compare said fingerprint files with the fingerprint image files stored in a database (not shown).

With the above descriptions, it is obvious that the embodiments and description are not indeed to limit the invention. The invention may be varied in many ways. Such variations are not to be regarded as a departure from the spirit and scope of the invention, and all such modifications as would be obvious to one skilled in the art are intended for inclusion within the scope of the following claims.

1. A two-in-one image display/image capture apparatus, comprising:
a flat display panel 2 which is non-transparent when said two-in-one image display/image capture apparatus displays images, and which is transparent when said two-in-one image display/image capture apparatus captures images;
a background light module 4 located behind said flat display panel 2, being turned on when said two-in-one image display/image capture apparatus displays images, and being turned off when said two-in-one image display/image capture apparatus captures images;
a flat display controller 14 which is used to receive image files from a main controller 8 when said two-in-one image display/image capture apparatus displays images and displays said image files on said flat display panel 2;
an image capturer 6 located behind said flat display panel 2, being turned off when said two-in-one image display/image capture apparatus displays images, and being turned on when said two-in-one image display/image capture apparatus captures images; and
a main controller 8 which is used to control the image display and image capture of said two-in-one image display/image capture apparatus, said main controller 8 transmitting pre-recorded image files to said flat display controller 14 and turning on said background light module 4 when said two-in-one image display/image capture apparatus displays images, and turning off said background light module 4 and turning on said image capturer 6 when said two-in-one image display/image capture apparatus captures images.

2. The two-in-one image display/image capture apparatus of claim 1, further comprises:
a background controller 16 which is used to turn on said background light module 4 when said two-in-one image display/image capture apparatus displays images, and which is used to turn off said background light module 4 when said two-in-one image display/image capture apparatus captures images.

3. The two-in-one image display/image capture apparatus of claim 2, further comprises:
a display memory device 22 which is used to store pre-stored image files and transmit said pre-stored image files to said flat display controller 14 when said two-in-one image display/image capture apparatus displays images.

4. The two-in-one image display/image capture apparatus of claim 3, further comprises:
an image capture controller 12 which is used to turn off said image capturer 6 when said two-in-one image display/image capture apparatus displays images, and which is used to turn on said image capturer 6 and transmit image files transmitted from said image capturer 6 to a image storage apparatus 20 when said two-in-one image display/image capture apparatus captures images.

5. The two-in-one image display/image capture apparatus of claim 4, further comprises:
a image storage apparatus 20 which is used to store image files transmitted from said image capture controller 12.

6. The two-in-one image display/image capture apparatus of claim 5, further comprises:
a two-in-one controller 10 which is used to control said background light controller 16 and said image capture controller 12, said two-in-one controller 10 turning on said background light module 4 through said background light controller 16 when said two-in-one image display/image capture apparatus displays images, and turning on said image capturer 6 through said image capture controller 12 when said two-in-one image display/image capture apparatus captures images.

7. The two-in-one image display/image capture apparatus of claim 1, wherein said flat display panel 2 is selected from the group consisting of liquid crystal display (LCD), organic electro-luminescence display (OELD) and field emission display (FED).

8. The two-in-one image display/image capture apparatus of claim 2, wherein said flat display panel 2 is selected from the group consisting of liquid crystal display (LCD), organic electro-luminescence display (OELD) and field emission display (FED).

9. The two-in-one image display/image capture apparatus of claim 3, wherein said flat display panel 2 is selected from the group consisting of liquid crystal display (LCD), organic electro-luminescence display (OELD) and field emission display (FED).

10. The two-in-one image display/image capture apparatus of claim 4, wherein said flat display panel 2 is selected from the group consisting of liquid crystal display (LCD), organic electro-luminescence display (OELD) and field emission display (FED).

11. The two-in-one image display/image capture apparatus of claim 5, wherein said flat display panel 2 is selected from the group consisting of liquid crystal display (LCD), organic electro-luminescence display (OELD) and field emission display (FED).

12. The two-in-one image display/image capture apparatus of claim 6, wherein said flat display panel 2 is selected from the group consisting of liquid crystal display (LCD), organic electro-luminescence display (OELD) and field emission display (FED).

13. The two-in-one image display/image capture apparatus of claim 1, wherein said two-in-one image display/image capture apparatus comprises a plurality of image capturer 6 located at different spots behind said flat display panel 2 in order to generate 3-dimentional (3D) images of the user.

14. The two-in-one image display/image capture apparatus of claim 2, wherein said two-in-one image display/image capture apparatus comprises a plurality of image capturer 6 located at different spots behind said flat display panel 2 in order to generate 3D images of the user.

15. The two-in-one image display/image capture apparatus of claim 3, wherein said two-in-one image display/image capture apparatus comprises a plurality of image capturer 6 located at different spots behind said flat display panel 2 in order to generate 3D images of the user.

16. The two-in-one image display/image capture apparatus of claim 4, wherein said two-in-one image display/image capture apparatus comprises a plurality of image capturer 6 located at different spots behind said flat display panel 2 in order to generate 3D images of the user.

17. The two-in-one image display/image capture apparatus of claim 5, wherein said two-in-one image display/image capture apparatus comprises a plurality of image capturer 6 located at different spots behind said flat display panel 2 in order to generate 3D images of the user.

18. The two-in-one image display/image capture apparatus of claim 6, wherein said two-in-one image display/image capture apparatus comprises a plurality of image capturer 6 located at different spots behind said flat display panel 2 in order to generate 3D images of the user.

19. The two-in-one image display/image capture apparatus of claim 1, wherein said two-in-one image display/image capture apparatus comprises a plurality of image capturer 6 behind said flat display panel 2 to capture images at different angles so that the user will have no place to hide.

20. The two-in-one image display/image capture apparatus of claim 2, wherein said two-in-one image display/image capture apparatus comprises a plurality of image capturer 6 behind said flat display panel 2 to capture images at different angles so that the user will have no place to hide.

21. The two-in-one image display/image capture apparatus of claim 3, wherein said two-in-one image display/image capture apparatus comprises a plurality of image capturer 6 behind said flat display panel 2 to capture images at different angles so that the user will have no place to hide.

22. The two-in-one image display/image capture apparatus of claim 4, wherein said two-in-one image display/image capture apparatus comprises a plurality of image capturer 6 behind said flat display panel 2 to capture images at different angles so that the user will have no to hide.

23. The two-in-one image display/image capture apparatus of claim 5, wherein said two-in-one image display/image capture apparatus comprises a plurality of image capturer 6 behind said flat display panel 2 to capture images at different angles so that the user will have no to hide at.

24. The two-in-one image display/image capture apparatus of claim 6, wherein said two-in-one image display/image capture apparatus comprises a plurality of image capturer 6 behind said flat display panel 2 to capture images at different angles so that the user will have no place to hide.

25. A method of using a two-in-one image display/image capture apparatus to form an electrical signature by recording operational display images and user images crossly, said method comprises the steps of:
(1) using said two-in-one image display/image capture apparatus to display the n-th of the totally m pre-stored image files on said flat display panel 2, said n-th pre-stored image file instructing the user to input the demanded data, wherein m≧1 and the pre-set value of n is 1 (when n is not reset);
(2) using said two-in-one image display/image capture apparatus to store the n-th pre-stored image file displayed on flat display panel 2;
the user inputting the demanded data based on the n-th pre-stored image file;
(3) using said two-in-one image display/image capture apparatus to store the image of the user through flat display panel 2 as user image files;
(4) using the two-in-one image display/image capture apparatus to check the relation of n and m, resetting n as n+1 and repeating the previous steps when n<m, resetting n as 1 when n=m and said two-in-one image display/image capture apparatus ending the electrical signature formed by storing the pre-stored image files and user image files crossly and returning back to step 1 to stand by.

26. An identification system using a two-in-one image display/image capture apparatus, comprises:
a two-in-one image display/image capture apparatus which comprises a region that instructs the user to corporate to capture image files for biological identification from, the region comprising at least one image capturer 6;
a database which is used to store a plurality of image files for biological identification; and
a processor which has an identification program, the processor is used to execute the identification program to compare the image files captures by the two-in-one image display/image capture apparatus with a plurality of image files stored in said database.

27. The identification system of claim 26, wherein said image files for identification is selected from the group consisting of irides files, fingerprint files and visage files.
